(19) United States
(12) Patent Application Publication
(10) Pub. No.: US 2025/0256399 A1
(43) Pub. Date: Aug. 14, 2025

(54) KERNEL-BASED ERGODIC SEARCH

(71) Applicants: Honda Motor Co., Ltd., Tokyo (JP); Northwestern University, Evanston, IL (US)

(72) Inventors: Muchen SUN, Evanston, IL (US); Ayush GAGGAR, Evanston, IL (US); Peter F. TRAUTMAN, Pebble Beach, CA (US); Todd David MURPHEY, Evanston, IL (US)

(21) Appl. No.: 18/914,929

(22) Filed: Oct. 14, 2024

Related U.S. Application Data
(60) Provisional application No. 63/553,544, filed on Feb. 14, 2024.

(51) Int. Cl. B25J 9/16; G06F 17/11

(52) U.S. Cl. CPC B25J 9/1664; G06F 17/11

(57) ABSTRACT

According to one aspect, kernel-based ergodic search using a robot may include receiving a target distribution indicative of a desired ergodic search coverage, generating a kernel-based ergodic metric based on the target distribution and a candidate trajectory, generating a kernel-based ergodic gradient based on the kernel-based ergodic metric, generating a trajectory based on the kernel-based ergodic gradient, and implementing the trajectory for the robot.

### CROSS-REFERENCE TO RELATED APPLICATIONS

This application claims the benefit of U.S. Provisional Patent Application, Ser. No. 63/553,544 (Attorney Docket No. H1240495US01) entitled “FAST ERGODIC SEARCH FOR EUCLIDEAN SPACE AND LIE GROUP”, filed on Feb. 14, 2024; the entirety of the above-noted application(s) is incorporated by reference herein.

### BACKGROUND

Robots often need to search an environment driven by a distribution of information of interest. Examples include search and rescue based on human annotated maps or aerial images, object tracking under sensory or motion uncertainty, and data collection in active learning. The success of such tasks depends on both the richness of the information representation and the effectiveness of the search algorithm. While advances in machine perception and sensor design have improved the quality of information representation, generating effective search strategies for the given information remains an open challenge.

Generally, ergodic search enables exploration of an information distribution while guaranteeing the asymptotic coverage of the search space. However, current methods typically have exponential computation complexity, which is undesirable, in the search space dimension and are generally restricted to Euclidean space or physical space. Therefore, higher dimensional searches currently require exponentially increasing computation resources. There are several limitations associated with a standard ergodic search: (1) a controller is limited with an infinitesimally small planning horizon; thus, it often requires an impractically long exploration period to generate good coverage; (2) it is costly to scale the standard ergodic metric to higher dimension spaces, (3) it is not trivial to generalize the metric to non-Euclidean spaces.

### BRIEF DESCRIPTION

According to one aspect, a computer-implemented method for kernel-based ergodic search using a robot may include receiving, via a processor, a target distribution indicative of a desired ergodic search coverage, generating, via a metric generator, a kernel-based ergodic metric based on the target distribution and a candidate trajectory, generating, via a gradient generator, a kernel-based ergodic gradient based on the kernel-based ergodic metric, generating, via a controller, a trajectory based on the kernel-based ergodic gradient, and implementing, via a trajectory controller, the trajectory for the robot.

According to one aspect, a system for kernel-based ergodic search using a robot may include a memory storing one or more instructions and a processor executing one or more of the instructions stored on the memory to perform one or more acts, actions, and/or steps, such as receiving a target distribution indicative of a desired ergodic search coverage, generating a kernel-based ergodic metric based on the target distribution and a candidate trajectory, generating a kernel-based ergodic gradient based on the kernel-based ergodic metric, and generating a trajectory based on the kernel-based ergodic gradient. The system for kernel-based ergodic search using a robot may include a trajectory controller implementing the trajectory for the robot.

According to one aspect, a robot for kernel-based ergodic search may include a memory storing one or more instructions and a processor executing one or more of the instructions stored on the memory to perform one or more acts, actions, and/or steps, such as receiving a target distribution indicative of a desired ergodic search coverage, generating a kernel-based ergodic metric based on the target distribution and a candidate trajectory, generating a kernel-based ergodic gradient based on the kernel-based ergodic metric, and generating a trajectory based on the kernel-based ergodic gradient. The robot for kernel-based ergodic search may include a trajectory controller and one or more actuators implementing the trajectory for the robot.

### BRIEF DESCRIPTION OF THE DRAWINGS

FIG. 1 is a flow diagram of a computer-implemented method for kernel-based ergodic search using a robot, according to one aspect.

FIG. 2 is a component diagram of a system or robot for kernel-based ergodic search, according to one aspect.

FIGS. 3A-3E are graphs related to kernel-based ergodic search using a robot, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a “robot” may include a machine which does not necessarily resemble a human, including a vehicle, a device, a flying robot, a manipulator, a robotic arm, one or more robot systems, etc. Further, a “robot” may refer to any moving vehicle that is capable of carrying one or more human occupants and is powered by any form of energy. The term “robot” may include cars, trucks, vans, minivans, SUVs, motorcycles, scooters, boats, personal watercraft, and aircraft. In some scenarios, a motor vehicle includes one or more engines. Further, the term “robot” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “robot” may refer to an autonomous vehicle and/or self-driving vehicle powered by any form of energy. The autonomous vehicle may or may not carry one or more human occupants.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

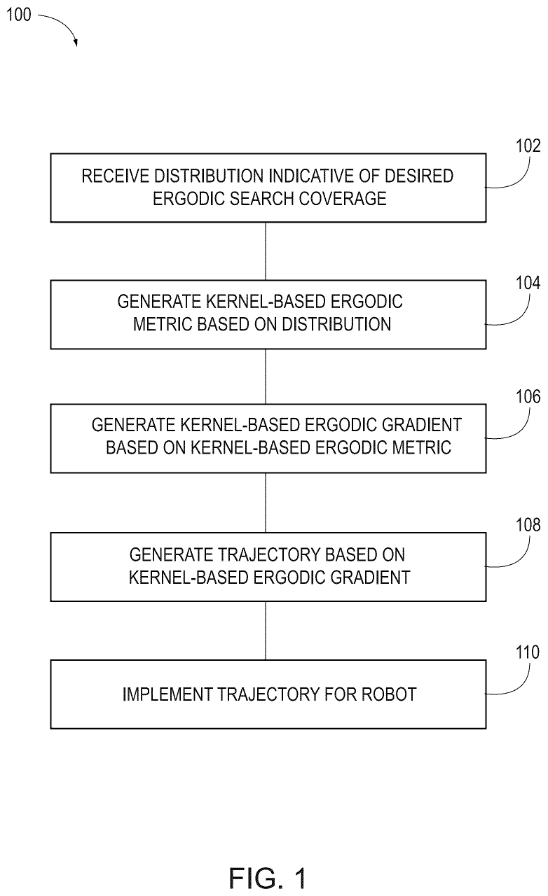

FIG. 1 is a flow diagram of a computer-implemented method 100 for kernel-based ergodic search using a robot, according to one aspect. For example, the computer-implemented method 100 for kernel-based ergodic search using a robot may include receiving 102, via a processor, a target distribution indicative of a desired ergodic search coverage. The target distribution may be a specification input to specify the desired ergodic search coverage. According to an example where the distribution is two-dimensional (2D), the distribution may be a 2D image. However, the distribution may often be in the form of a higher dimensional (e.g., greater than 2D) input, such as three-dimensional, four-dimensional, five-dimensional, six-dimensional, etc. The computer-implemented method 100 for kernel-based ergodic search using a robot may include generating 104, via a metric generator, a kernel-based ergodic metric based on the target distribution and a candidate trajectory. The candidate trajectory may be initially provided as an initial input, but later be provided as a trajectory output by a controller, and iteratively refined, as described herein. The computer-implemented method 100 for kernel-based ergodic search using a robot may include generating 106, via a gradient generator, a kernel-based ergodic gradient based on the kernel-based ergodic metric, generating 108, via a controller, a trajectory based on the kernel-based ergodic gradient, and implementing 110, via a trajectory controller, the trajectory for the robot. As discussed herein, the trajectory output by the controller may be fed back to the metric generator as the candidate trajectory, and the computer-implemented method 100 for kernel-based ergodic search using a robot may be iterated as desired.

The trajectory output by the controller may be a trajectory that generates the desired ergodic search coverage according to the distribution provided initially. Additionally, the trajectory may be represented such that a time history of the trajectory represents the desired ergodic search coverage according to the target distribution.

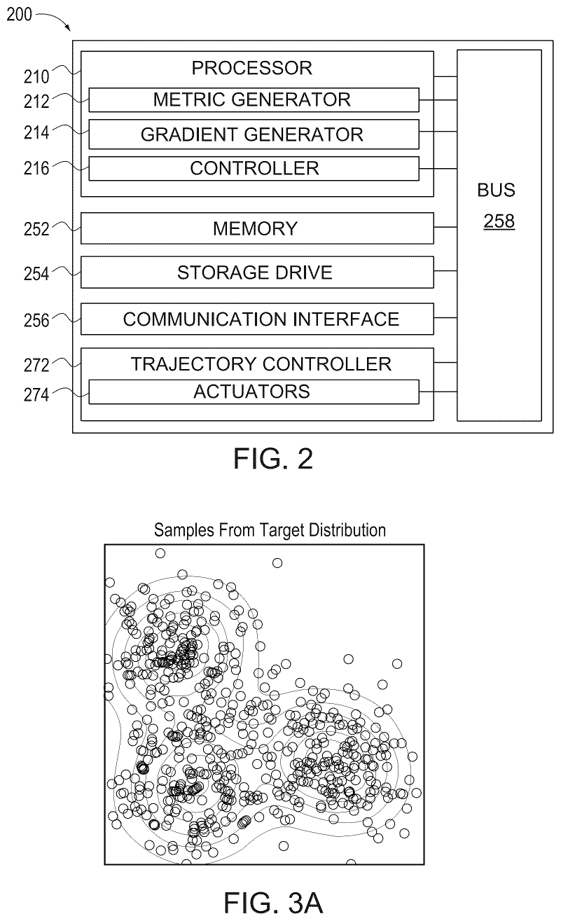

FIG. 2 is a component diagram of a system 200 or robot for kernel-based ergodic search, according to one aspect. The system 200 or robot for kernel-based ergodic search is described with reference to the computer-implemented method 100 for kernel-based ergodic search using the robot of FIG. 1, and may include a processor, a metric generator, a gradient generator 214, and a controller 216. The metric generator, the gradient generator 214, and the controller 216 may be implemented via the processor. The system 200 or robot for kernel-based ergodic search may include a memory 252, a storage drive 254, a communication interface 256, a bus, and a trajectory controller 272. The trajectory controller 272 may include one or more actuators 274. The bus 258 may operably connect and enable computer communication between respective components of the system 200 or robot for kernel-based ergodic search. For example, the processor, the metric generator, the gradient generator 214, the controller 216, the memory 252, the storage drive 254, the communication interface 256, the trajectory controller 272, and the one or more actuators 274 may be operably connected to the bus.

### Ergodic Theory

Generally, ergodic theory studies the connection between the time averaged and space averaged behaviors of a dynamical system. Originating in statistical mechanics, ergodic theory has now expanded to a full branch of mathematics with deep connections to other branches, such as information theory, measure theory, and functional analysis. For decision making, ergodic theory provides formal principles to reason over decisions based on the time and space averaged behaviors of the environment or of the agent itself. As used herein, “ergodicity”, may be utilized in the context of a search task given as the difference between the time averaged spatial statistics of the agent's trajectory and the target information distribution to perform a search. A quantitative measure of such difference is also introduced as a spectral multi scale coverage (SMC) metric (herein the “standard ergodic metric”), as well as a closed form model predictive controller with infinitesimally small planning horizon for both first order and second order linear dynamical systems.

Ergodic search has been applied to generate informative search behaviors in robotic applications, including multi-modal target localization, object detection, imitation learning, robotic assembly, and automated data collection for generative models. Additionally, the standard ergodic metric has been applied to non-search robotic applications, such as point cloud registration. Furthermore, ergodic search has also been extended to better satisfy other requirements from common robotic tasks, such as safety critical search, multi objective search, and time optimal search.

### Formulations—Notations

The metric generator, implemented via the processor, may generate a kernel-based ergodic metric according to the following:

A state of a robot may be denoted as s∈S, where S is a bounded set within an n-dimensional Euclidean space. The state of the robot may be advantageously extended to Lie groups. The robot's motion may be governed by the following dynamics:

$$\dot{s} ( t ) = f ( s ( t ) , u ( t ) ) \qquad ( 1 )$$

where u(t)∈ [symbol] ∈ [symbol] ^{m} is a control signal for a trajectory generated by the controller 216, for example. The dynamics of function ƒ(⋅,⋅) is differentiable with respect to both s(t) and u(t). A probability density function may be defined over a bounded state space S and P(x):S [symbol] , which satisfies:

$${\int }_{S} P ( x ) d x = 1 and P ( x ) \geq 0 , ∀ x ∈ S \qquad ( 2 )$$

As used herein, a “trajectory” may be defined for s(t):[0, T] [symbol] S as a continuous mapping from time to a state in the bounded state space S.

As used herein, “trajectory empirical distribution” may be defined as follows: given a trajectory s(t):[0,T] [symbol] S for a robot, the empirical distribution of the trajectory s(t) may be represented as:

$${C}_{s} ( x ) = \frac{1}{T} {\int }_{0}^{T} {δ}_{s ( t )} ( x ) d t \qquad ( 3 )$$

where δₛ₍ₜ₎(x) is a Dirac delta function. Here, the trajectory empirical distribution Cₛ(x) has a valid probability density function. The trajectory empirical distribution Cₛ(x) may be referred to as the time-averaged statistics of the trajectory since the trajectory empirical distribution Cₛ(x) represents the likelihood of each region being visited by the robot. The trajectory empirical distribution Cₛ(x) transforms the trajectory, as a function of time, to a spatial distribution in order to evaluate ergodicity.

### Formulation—Ergodicity

A dynamic system is ergodic with respect to a spatial distribution if and only if the system visits any region of the space for an amount of time proportional to the integrated value of the target distribution over the region. Stated another way, a dynamic system is ergodic if the empirical distribution of its trajectory is the same as the spatial distribution, as the time horizon approaches infinity.

As used herein, an “ergodic system” may be defined as follows: given a spatial distribution P(x), a dynamical system, with its trajectory denoted as s(t), is ergodic with respect to the spatial distribution P(x) if and only if the following Equation (4) is satisfied:

$$P ( x ) = {lim}_{T \to ∞} {C}_{s} ( x ) , ∀ x ∈ S \qquad ( 4 )$$

In other words, an ergodic system's trajectory empirical distribution Cₛ(x), at the limit of the infinite time horizon, is the same as the target distribution.

Regarding asymptotic coverage, if the spatial distribution P(x) has a non-zero density at any point of the state space S, an ergodic system, while systematically spending more time over regions with higher information density and less time over regions with less information density, will eventually visit any and/or every possible state in the state space S as the time approaches infinity.

However, standard ergodic systems are infeasible in practice for several reasons: (1) standard ergodic systems may only evaluate systems with infinitely-long time horizons; and (2) the trajectory empirical distribution Cₛ(x) requires an evaluation of the Dirac delta function, which may only be evaluated in theory because of its infinite magnitude. For a robotic task, it may be desired to quantify how “ergodic” a finite-horizon trajectory is, given a spatial distribution P(x). By optimizing such a quantifiable metric as the objective for an optimal control or trajectory optimization problem, a robot may optimally explore the spatial distribution P(x) within a limited amount of time while knowing the asymptotic coverage property of an ergodic system, eventually guides the robot to cover the entire space. This motivates the derivation of the kernel-based ergodic metric, described in greater detail herein.

### Formulation—Standard Ergodic Metric

Generally, an ergodic search generates a control signal for a dynamic system to maximize its ergodicity within a given spatial distribution P(x). Stated another way, an ergodic search controls a dynamic system to “match” the empirical distribution (e.g., trajectory empirical distribution Cₛ(x)) of its trajectory with the spatial distribution P(x).

In other words, an ergodic metric measures the time averaged behavior of a dynamical system with respect to the spatial distribution P(x). A dynamic system is ergodic with respect to the spatial distribution P(x) if the system visits any region of the space for an amount of time proportional to the integrated value of the target distribution over the region. Optimizing the ergodic metric guides the robot to cover the whole search space asymptotically while investing more time in areas with higher information values. However, despite the theoretical advantages and tight connections to biological systems, current ergodic search methods are not suitable for many robotic tasks. The standard ergodic metric has an exponential computation complexity in the search space dimension, thereby limiting its applications in spaces with fewer than three dimensions. In this way, the standard ergodic metric is restricted to the Euclidean space. Moreover, common robotic tasks, such as vision-related or manipulation-related tasks, often require operations in non-Euclidean spaces, such as in the space of rotations or rigid body transformations.

The standard ergodic metric is formulated as a Sobolev norm through the Fourier transformation of the target distribution and the trajectory empirical distribution Cₛ(x). The formula of the standard ergodic metric is described below.

As used herein, an “Fourier basis function” may be defined as follows: the standard ergodic metric assumes the robot operates in a n-dimensional rectangular Euclidean space, denoted as S=[0,L₁]× . . . ×[0,Lₙ]. The Fourier basis function ƒₖ(x): S [symbol] is defined as:

$${f}_{k} ( x ) = \frac{1}{{h}_{k}} {\prod }_{i = 1}^{n} cos ( \frac{{k}_{i} π}{{L}_{i}} {x}_{i} ) \qquad ( 5 )$$

where
x=[x₁, x₂, . . . , xₙ]∈S;
k=[k₁, k₂, . . . , kₙ]∈ [symbol] ∈ [symbol] ⁿ;
[symbol] =[0, 1, . . . , K₁]× . . . ×[0, 1, . . . , Kₙ]; and
hₖ is a normalization term such that the function space norm of each basis function is 1.

Thus, the set of Fourier basis functions forms a set of orthonormal basis functions. This means both the target spatial distribution and the trajectory empirical distribution Cₛ(x) may be represented as the weighted sum of the Fourier basis functions.

As used herein, “standard ergodic metric” may be defined as follows: given an n-dimensional spatial distribution P(x) and a dynamical system with the trajectory s(t) over a finite time horizon [0, T], the standard ergodic metric, denoted as ε, is defined as:

$$ℰ ( P ( x ) , s ( t ) ) = {{Λ}_{k} ( {p}_{k} - {c}_{k} )}^{2} \qquad ( 6 )$$

where the sequences of {pₖ} [symbol] and {cₖ} [symbol] are the sequences of Fourier decomposition coefficients of the target distribution and trajectory empirical distribution Cₛ(x), respectively:

$${p}_{k} = {\int }_{S} P ( x ) {f}_{k} ( x ) dx \qquad ( 7 )$$

$${c}_{k} = {\int }_{S} {C}_{s} ( x ) {f}_{k} ( x ) d x = \frac{1}{T} {\int }_{0}^{T} {f}_{k} ( s ( t ) ) d t \qquad ( 8 )$$

The sequence of {Λₖ} is a convergent real sequence and is defined as:

$${Λ}_{k} = {( 1 + ‖ k ‖ )}^{- \frac{n + 1}{2}} \qquad ( 9 )$$

In practice, by choosing a finite number of Fourier basis functions, the standard ergodic metric ε may approximate ergodicity on a system with a finite time horizon. While a greater number of Fourier basis functions may lead to better approximations, the greater number of Fourier basis functions also requires more computational resources.

With the time horizon T and the number of Fourier basis functions approaching infinity, a dynamical system is globally optimal under the standard ergodic metric ε if and only if the system satisfies the original definition of an ergodic system from Equation (4).

The standard ergodic metric ε is a distance metric given by the Sobolev space norm of negative index

$$- \frac{n + 1}{2} :$$

$$ℰ ( P ( x ) , s ( t ) ) = {‖ P ( x ) - {C}_{s} ( x ) ‖}_{{H}^{- \frac{n + 1}{2}}}^{2} . \qquad ( 10 )$$

As discussed herein, one drawback to the standard ergodic metric ε of Equation (6) is the number of Fourier basis functions, which are associated with computational bottlenecks. Studies have revealed that a sufficient number of the basis functions for practical applications grows exponentially with the search space dimension, creating a significant challenge to apply the standard ergodic metric E in higher-dimensional spaces. Further, deriving the Fourier basis function in these spaces such as Lie groups is non-trivial, limiting the generalization of the standard ergodic metric ε.

### Kernel-Based Ergodic Metric and Advantages

According to one aspect, the kernel-based ergodic metric may be formulated or expressed in terms of kernels. For example, the kernel-based ergodic metric may be formulated or expressed in terms of a delta kernel. Additionally, the kernel-based ergodic metric may be based on an L2 distance between a target information distribution and a spatial empirical distribution of a trajectory (e.g., candidate trajectory). Thus, the metric generator 212 may generate the kernel-based ergodic metric based on the target distribution and a candidate trajectory. According to one aspect, the candidate trajectory may be provided as an initial guess. For example, the metric generator 212 may estimate an initial candidate trajectory by approximating the candidate trajectory based on a nearest-neighbor approach.

This kernel-based ergodic metric provides the advantages and benefits of being asymptotically consistent with currently used standard ergodic search methods while being numerically efficient and guaranteeing linear complexity in the search space dimension (e.g., having linearly scaled computational requirements rather than exponentially scaled computational requirements), thereby enabling scaling beyond 2D spaces. Further, the kernel-based ergodic metric may be advantageously generalized to non-Euclidean spaces, such as Lie groups, as discussed herein. In this way, the kernel-based ergodic search provided herein enables an optimal balance between information maximization and uniform coverage (e.g., entropy maximization).

As discussed herein, the processor 210 may receive a target distribution indicative of a desired ergodic search coverage. Further, because the ergodic metric is a kernel-based ergodic metric, learning from demonstration (LfD) may be advantageously implemented using insufficient or unsuccessful demonstrations rather than successful demonstrations and without any sensor feedback. Ergodicity guarantees an asymptotic solution for a problem so long as a solution resides within the prior information distribution, and thus, a 100% success rate may be guaranteed. In this way, the kernel-based ergodic metric may be derived and ergodicity may be computed as a summation of an integrated likelihood of the trajectory s(t) within the spatial distribution P(x) and the uniformity of the trajectory s(t) measured with the kernel function.

### Kernel-Based Ergodic Metric—Derivation

The metric generator 212 may generate the kernel-based ergodic metric based on an L2-norm distance formula for ergodicity, described in greater detail herein. In this regard, the Sobolev-norm and L2-norm formulas are asymptotically consistent as both converge to the definition of ergodic system in Equation (4), but the L2-norm formula leads to a more computationally efficient metric for ergodicity. The metric generator 212 may generate the kernel-based ergodic metric based on an L2 distance between the target information distribution (e.g., spatial distribution P(x)) and the trajectory empirical distribution Cₛ(x) as follows:

$${\int }_{S} {[ P ( x ) - {C}_{s} ( x ) ]}^{2} dx = \qquad ( 11 )$$

$${\int }_{S} [ {P ( x )}^{2} - 2 P ( x ) {C}_{s} ( x ) + {{C}_{s} ( x )}^{2} ] dx = \qquad ( 12 )$$

$${\int }_{S} {P ( x )}^{2} dx - 2 {\int }_{S} P ( x ) {C}_{s} ( x ) dx + {\int }_{S} {{C}_{s} ( x )}^{2} dx \qquad ( 13 )$$

The first term of Equation (13) may be dropped since the norm of the target distribution ∥P(x)∥²=∫_{S}P(x)²dx does not depend on s(t) and is a constant given a target spatial distribution:

$$\begin{matrix}arg min \\ s ( t )\end{matrix} ‖ P ( x ) ‖ - 2 {\int }_{S} P ( x ) {C}_{s} ( x ) dx + {\int }_{S} {{C}_{s} ( x )}^{2} dx = \begin{matrix}arg min \\ s ( t )\end{matrix} - 2 {\int }_{S} P ( x ) {C}_{s} ( x ) dx + {\int }_{S} {{C}_{s} ( x )}^{2} dx \qquad ( 14 )$$

Substituting the definition of trajectory empirical distribution Cₛ(x) from Equation (3) to Equation (14). For the first term in Equation (14):

$${\int }_{S} P ( x ) {C}_{s} ( x ) dx = {\int }_{S} P ( x ) [ \frac{1}{T} {\int }_{0}^{T} {δ}_{s ( f )} ( x ) dt ] dx = \qquad ( 15 )$$

$$\frac{1}{T} {\int }_{0}^{T} [ {\int }_{S} P ( x ) {δ}_{s ( f )} ( x ) dx ] dt = \qquad ( 16 )$$

$$\frac{1}{T} {\int }_{0}^{T} P ( s ( t ) ) dt \qquad ( 17 )$$

Equations (16) and (17) are based on a property of the Dirac delta function. For the second term in Equation (14):

$${\int }_{S} {{C}_{s} ( x )}^{2} dx = {\int }_{S} {[ \frac{1}{T} {\int }_{0}^{T} {δ}_{s ( f )} ( x ) dt ]}^{2} dx = \qquad ( 18 )$$

$$\frac{1}{{T}^{2}} {\int }_{0}^{T} {\int }_{0}^{T} [ {\int }_{S} {δ}_{s ( {f}_{1} )} ( x ) {δ}_{s ( {t}_{2} )} ( x ) dx ] {dt}_{1} {dt}_{2} \qquad ( 19 )$$

$$\frac{1}{{T}^{2}} {\int }_{0}^{T} {\int }_{0}^{T} ϕ ( s ( {t}_{1} ) , s ( {t}_{2} ) ) {dt}_{1} {dt}_{2} \qquad ( 20 )$$

where ϕ(x₁, x₂) is a delta kernel defined as:

$$ϕ ( {x}_{1} , {x}_{2} ) = \{ \begin{matrix}+ ∞ , if {x}_{1} = {x}_{2} \\ 0 , otherwise\end{matrix} \qquad ( 21 )$$

Substituting Equations (17) and (20) into Equation (14) results in the kernel-based ergodic metric as:

$${ε}_{ϕ} ( s ( t ) ) = - \frac{2}{T} {\int }_{0}^{T} P ( s ( t ) ) dt + \frac{1}{{T}^{2}} {\int }_{0}^{T} {\int }_{0}^{T} ϕ ( s ( {t}_{1} ) , s ( {t}_{2} ) ) {dt}_{1} {dt}_{2} \qquad ( 22 )$$

Therefore, P(s(t)) represents the target spatial distribution and ϕ(s(t₁),s(t₂)) represents the kernel function (e.g., delta kernel, but any other kernel may be utilized, such as radial basis function kernels). The first term

$$( e . g . , - \frac{2}{T} {\int }_{0}^{T} P ( s ( t ) ) dt )$$

of Equation (22) facilitates achieving information maximization (e.g., information maximization element) while the second term

$$( e . g . , \frac{1}{{T}^{2}} {\int }_{0}^{T} {\int }_{0}^{T} ϕ ( s ( {t}_{1} ) , s ( {t}_{2} ) ) {dt}_{1} {dt}_{2} )$$

facilitates achieving uniform coverage or entropy maximization (e.g., uniform coverage element). In this way, a kernel-based ergodic search may be provided to achieve an optimal balance between information maximization and uniform coverage (e.g., entropy maximization) and includes an information maximization element and a uniform coverage element.

In practice, the kernel ϕ(⋅,⋅) may be approximated in various forms and results hold as long as the kernel function asymptotically converges to a delta kernel. For example, Equation (22) may be specified with the squared exponential kernel function, the rational quadratic kernel function, γ-exponential kernel function, the Matérn class of kernel functions, etc. As will be described herein, the kernel-based ergodic metric is formulated as a Gaussian (e.g., squared exponential) kernel:

$$ϕ ( {x}_{1} , {x}_{2} ; \sum ) = \frac{exp ( \frac{1}{2} {( {x}_{1} - {x}_{2} )}^{T} {\sum }^{- 1} ( {x}_{1} - {x}_{2} ) )}{\sqrt{{( 2 π )}^{n} det ( \sum )}} \qquad ( 23 )$$

Where Σ is a n-by-n covariance matrix of the kernel and ε_{ϕ}(s(t)) is the kernel-based ergodic metric.

With the time horizon T approaching infinity and the kernel approaching a delta kernel of Equation (21), a dynamical system is globally optimal under the kernel-based ergodic metric ε_{ϕ}(s(t)) of Equation (22) if and only if the system satisfies the original definition of an ergodic system from Equation (4).

With the time horizon T approaching infinity and the kernel approaching the delta kernel of Equation (21), the kernel-based ergodic metric ε_{ϕ}(s(t)) of Equation (22) converges to the L2-distance of Equation (11). Since the L2-distance of Equation (11) is a convex metric with a global minima of 0, a dynamic system that is globally optimal under the kernel-based ergodic metric ε_{ϕ}(s(t)) of Equation (22) must satisfy:

$$P ( x ) = {C}_{s} ( x ) , ∀ x ∈ S \qquad ( 24 )$$

which is equivalent to the definition of ergodic system in Equation (4).

The kernel-based ergodic metric ε_{ϕ}(s(t)) of Equation (22) does not require the search space to be rectangular as required by the standard ergodic metric ε. Instead, the kernel-based ergodic metric ε_{ϕ}(s(t)) merely requires the search space to be bounded.

### Kernel-Based Ergodic Metric—Intuition

The formula for kernel-based ergodic metric ε_{ϕ}(s(t)) of Equation (22) is the summation of two elements

$$- \frac{2}{T} {\int }_{0}^{T} P ( s ( t ) ) dt and \frac{1}{{T}^{2}} {\int }_{0}^{T} {\int }_{0}^{T} ϕ ( s ( {t}_{1} ) , s ( {t}_{2} ) ) {dt}_{1} {dt}_{2} .$$

Minimizing the kernel-based ergodic metric ε_{ϕ}(s(t)), which is equivalent to simultaneously minimizing the two elements, represents a balance between information maximization and uniform coverage.

For the first term, since P(x) is the probability density function of the target distribution, minimizing

$$- \frac{2}{T} {\int }_{0}^{T} P ( s ( t ) ) dt$$

drives the system to the state with the maximum likelihood within the spatial distribution P(x). For the second term in the kernel-based ergodic metric, minimizing the kernel-based ergodic metric ε_{ϕ}(s(t)) drives the system to cover the search space uniformly. In other words, the trajectory s(t) that minimizes

$$\frac{1}{{T}^{2}} {\int }_{0}^{T} {\int }_{0}^{T} ϕ ( s ( {t}_{1} ) , s ( {t}_{2} ) ) {dt}_{1} {dt}_{2}$$

uniformly covers the search space S.

As discussed, the kernel-based ergodic metric ε_{ϕ}(s(t)) is the summation of the integrated likelihood of the trajectory s(t) within the spatial distribution P(x) and the uniformity of the trajectory s(t) within the search space measured by the kernel function. In other words, an ergodic system exhibits both information maximization behavior and uniform coverage behavior.

### Kernel-Based Ergodic Metric—Optimal Kernal Parameter

The metric generator 212 may generate the kernel-based ergodic metric ε_{ϕ}(s(t)) based on the target distribution and the candidate trajectory.

Since the delta kernel may be approximated by a Gaussian kernel from Equation (23), a parameter of the Gaussian kernel (e.g., a covariance matrix) may be optimized. According to one aspect, optimization may be based on a convergence property of the empirical distribution.

Assume s̅={sₜ} is a trajectory of a discrete dynamical system, with a total number of time steps N, where each state sₜ is an independent and identically distributed (IID) sample from the target distribution P(x). The following equation holds:

$${lim}_{N \to ∞} {C}_{\overline{s}} ( x ) = {lim}_{N \to ∞} [ \frac{1}{N} {\sum }_{t = 1}^{N} {δ}_{s ( t )} ( x ) ] = P ( x ) , ∀ x ∈ S \qquad ( 25 )$$

$${lim}_{N \to ∞} ‖ \frac{d}{d \overline{s}} [ {\int }_{S} {( {C}_{s} ( x ) - P ( x ) )}^{2} dx ] ‖ = 0 \qquad ( 26 )$$

The L2 distance may be replaced by the kernel-based ergodic metric ε_{ϕ}(s(t)), but instead of a continuous time integral, a discrete Monte Carlo (MC) integral formula may be utilized:

$${lim}_{N \to ∞} ‖ \frac{d}{d \overline{s}} J ( \overline{s} ) ‖ = 0 \qquad ( 27 )$$

$$J ( \overline{s} ) = - \frac{1}{N} {\sum }_{t = 1}^{N} P ( {s}_{t} ) + \frac{1}{{N}^{2}} {\sum }_{{t}_{1} = 1}^{N} {\sum }_{{t}_{2} = 1}^{N} ϕ ( {s}_{{t}_{1}} , {s}_{{t}_{2}} ) \qquad ( 28 )$$

With reference to Equation (27), it appears that a set of IID samples from the target distribution are close to an optimum under the kernel-based ergodic metric ε_{ϕ}(s(t)). Optimal kernel parameters may be selected by the metric generator 212 by minimizing the derivative of the samples with respect to the kernel-based ergodic metric ε_{ϕ}(s(t)). This objective function may be defined for automatic kernel parameter selection:

As used herein, “kernel parameter selection objective” may be defined as follows: given a set of samples s̅={sᵢ} from the target distribution, denote a kernel as ϕ(⋅,⋅; θ) with θ being the kernel parameter, the kernel parameter selection objective function for automatic kernel parameter selection is:

$$J ( \overline{s} ; θ ) = {‖ \frac{d}{d \overline{s}} ( - \frac{1}{N} {\sum }_{t = 1}^{N} P ( {s}_{t} ) + \frac{1}{{N}^{2}} {\sum }_{{t}_{1} = 1}^{N} {\sum }_{{t}_{2} = 1}^{N} ϕ ( {s}_{{t}_{1}} , {s}_{{t}_{2}} ; θ ) ) ‖}^{2} \qquad ( 29 )$$

In this way, the metric generator 212 may determine an optimal kernel parameter by minimizing the kernel parameter selection objective from Equation (29).

With a Gaussian kernel, as well as other kernel functions that are differentiable with respect to the parameter, the kernel parameter selection objective function is differentiable and may be optimized based on iterative optimization. If the metric generator 212 did not perform optimal kernel parameter selection based on the kernel parameter selection objective function from Equation (29), a neural network would be required to be generated based on a plurality of images that outputs a plurality of delta kernels and corresponding approximations along with a learning network that predicts optimal functions for use, thereby consuming a massive amount of computing resources.

### Control—Kernel-Based Ergodic Metric

The kernel-based ergodic metric ε₉₉ (s(t)) may be optimized when the trajectory s(t) is governed by a non-linear dynamical system. Even though the kernel-based ergodic metric ε₉₉ (s(t)) has a double time-integral structure that is uncommon among standard optimal control formulas, the optimization may be solved through optimal control techniques, such as a linear-quadratic regulator (LQR).

### Control—First Order Optimality Condition

The metric generator 212 may derive a first order optimality condition of the kernel-based ergodic metric ε_{ϕ}(s(t)) for non-linear systems, which enables efficient trajectory optimization. The metric generator 212 may derive the first order optimality condition based on Pontryagin's maximum principle, thereby enabling an iterative application of LQR technique for efficient ergodic trajectory optimization.

The metric generator 212 may formulate the optimal control problem for the kernel-based ergodic metric ε_{ϕ}(s(t)) and derive a first-order optimality condition for the optimal control problem based on the kernel-based ergodic metric ε_{ϕ}(s(t)).

As used herein, “kernel ergodic control” may be defined as follows: given a target distribution P(x) and system dynamics \dot{s}(t)=f(s(t), u(t)), kernel ergodic control is defined as the following optimization problem:

$${u}^{*} ( t ) = \begin{matrix}arg min J ( u ( t ) ) \\ u ( t )\end{matrix} \qquad ( 30 )$$

$$J ( u ( t ) ) = {ε}_{ϕ} ( s ( t ) ) + {\int }_{0}^{T} l ( s ( t ) , u ( t ) ) dt + m ( s ( T ) ) \qquad ( 31 )$$

$$s . t . s ( t ) = {s}_{0} + {\int }_{0}^{T} f ( s ( τ ) , u ( τ ) ) d τ \qquad ( 32 )$$

where l(⋅,⋅) and m(⋅) are the additional run-time cost and terminal cost of the task, respectively.

The derivation of the first order optimality condition for the above optimal control problem is based on the following:

Given a dynamical system \dot{s}(t)=f(s(t), u(t))∈ [symbol] ⁿ with the initial state s(0)=s₀, denote v(t) as the perturbation on u(t) and z(t) as the resulting perturbation on s(t), z(t), and v(t) are governed by a linear dynamics with z(0)=0∈ [symbol] ⁿ:

$$\dot{z} ( t ) = A ( t ) z ( t ) + B ( t ) v ( t ) \qquad ( 33 )$$

$$A ( t ) = {D}_{1} f ( s ( t ) , u ( t ) ) , B ( t ) = {D}_{2} f ( s ( t ) , u ( t ) ) \qquad ( 34 )$$

The first-order condition for u(t) to minimize the objective of Equation (31) is:

$${ρ ( t )}^{τ} B ( t ) + {b ( t )}^{τ} = 0 , ∀ t ∈ [ 0 , T ] \qquad ( 35 )$$

$$where$$

$$B ( t ) = \frac{d}{du} f ( s ( t ) , u ( t ) ) , b ( t ) = \frac{d}{du} l ( s ( t ) , u ( t ) ) \qquad ( 36 )$$

$$and$$

$$\dot{ρ} ( t ) = - {A ( t )}^{τ} ρ ( t ) - a ( t ) \qquad ( 37 )$$

$$ρ ( T ) = Dm ( s ( T ) ) \qquad ( 38 )$$

$$A ( t ) = \frac{d}{ds} f ( s ( t ) , u ( t ) ) \qquad ( 39 )$$

$$a ( t ) = - \frac{2}{T} DP ( s ( t ) ) + \frac{d}{ds} l ( s ( t ) , u ( t ) ) + \frac{2}{{T}^{2}} {\int }_{0}^{T} {D}_{1} ϕ ( s ( t ) , s ( τ ) ) d τ \qquad ( 40 )$$

where D₁ϕ(⋅,⋅) denotes the derivative of ϕ with respect to its first argument.

Given a nominal control u(t) and the resulting state trajectory s(t), the Gateaux derivative of the kernel ergodic control objective from Equation (31) is the derivative of the objective in the direction of a perturbation v(t) on the control, which leads to a perturbation z(t) on the state, and may be computed as:

$$DJ ( u ( t ) ) \cdot v ( t ) = {\int }_{0}^{T} {a ( t )}^{τ} z ( t ) + {b ( t )}^{τ} v ( t ) dt + {γ}^{τ} z ( T ) \qquad ( 41 )$$

$$where$$

$${γ}^{τ} = Dm ( s ( T ) ) \qquad ( 42 )$$

and a(t) and b(t) are defined in Equations (40) and (36), respectively.

The gradient generator may generate a kernel-based ergodic gradient based on the kernel-based ergodic metric ε_{ϕ}(s(t)) and based on Equation (41) (e.g., the nominal control u(t), the resulting state trajectory s(t), the Gateaux derivative of the kernel ergodic control objective from Equation (31), the derivative of the objective in the direction of a perturbation v(t) on the control, the perturbation z(t) on the state, etc.).

### Control—Iterative Optimal Control

The first-order optimality Equation (35) may be utilized to generate optimal control under the kernel-based ergodic metric ε_{ϕ}(s(t)) by an iterative algorithm, described herein.

Equation (41) provides the closed-form expression for the descent direction of the kernel ergodic control objective and the perturbation is governed by a linear dynamics. Thus, instead of directly solving the optimization problem, the controller 216 may iteratively optimize the descent direction with a quadratic cost, which has a closed-form solution through LQR based on the kernel-based ergodic metric ε_{ϕ}(s(t)) and the kernel-based ergodic gradient. Therefore, the sub-objective for finding the optimal descent direction J_{ζ}(v(t)) is defined as:

$${J}_{ζ} ( v ( t ) ) = DJ ( u ( t ) ) \cdot v ( t ) + {\int }_{0}^{T} {z ( t )}^{τ} Q ( t ) z ( t ) + {v ( t )}^{τ} R ( t ) v ( t ) dt = \qquad ( 43 )$$

$${\int }_{0}^{T} {a ( t )}^{T} z ( t ) + {b ( t )}^{τ} v ( t ) dt + {γ}^{τ} z ( T ) + {\int }_{0}^{T} {z ( t )}^{τ} Q ( t ) z ( t ) + {v ( t )}^{τ} R ( t ) v ( t ) dt \qquad ( 44 )$$

After finding the optimal descent direction in each iteration, the metric generator 212 may update the current control u(t) by choosing a step size for the descent direction, which may be fixed through tuning or adaptive through line search. The iterative optimal control process may be performed by the metric generator 212 according to Algorithm 1 below:

Algorithm 1 (kernel-based ergodic trajectory optimization)

```
1: procedure trajectory optimization (s₀, ū(t))
  2: k ← 0, where [symbol]     k is the iteration index
  3: uₖ(t) ← ū(t)
  4: while a termination criterion is not met do
    5: simulate sₖ(t) given s₀ and uₖ(t)
    6: vₖ(t) ← argminᵥ₍ₜ₎ J_{ζ}(v(t)) [symbol]     Equation (44)
    7: find step size η [symbol]     fixed or apply line search
    8: uₖ₊₁(t) ← uₖ(t) + η · uₖ(t)
    9: k ← k + 1
  10: end while
  11: return uₖ(t)
12: end procedure trajectory optimization
```

In this way, the controller 216 may generate a control signal for the trajectory s(t) based on the kernel-based ergodic gradient and the kernel-based ergodic metric. For example, the controller 216 may generate the control signal for the trajectory s(t) by iteratively solving the LQR problem based on Algorithm 1.

### Control—Enhancing Optimization

According to one aspect, additional approaches to accelerate or enhance the computation of Algorithm 1 may be provided. For example, a first approach is a bootstrap method that provides an initial control ū(t) to the Algorithm 1 that is closer to the optimum. The second approach parallelizes the computation of the descent direction to speed up each iteration of the Algorithm 1 among multiple processors.

### Control—Enhancing Optimization Via Bootstrap

The processor 210 may guide the initial control to roughly cover the target distribution. For example, to achieve this initial control, a trajectory tracking problem may be formulated for the initial control to track over an ordered set of samples from the target distribution. The order of the samples is determined by a rapid approximation of a traveling-salesman problem (TSP). Neither the solution of TSP nor trajectory tracking is required to be accurate. For example, the TSP solution may be approximated through a nearest-neighbor approach, which has a maximum quadratic complexity, and the trajectory tracking problem may be computed through any iterative optimization method for a few iterations, without strict convergence criterion.

### Control—Enhancing Optimization Via Parallelization

The time integral term in the descent direction formula of Equation (40) is:

$${\int }_{0}^{T} {D}_{1} ϕ ( s ( t ) , s ( τ ) ) d τ \qquad ( 45 )$$

and is the summation of the derivative of kernel correlation between the state at time t and the whole trajectory. Since the evaluation of the kernel correlations in each time step are independent of one another, this integral may be computed in parallel. Similarly, the computation of the kernel ergodic control objective from Equation (31) may also be parallelized during the linear search in each iteration.

### Lie Groups—Kernel-Based Ergodic Control

As discussed herein, the kernel-based ergodic metric ε_{ϕ}(s(t)) may be advantageously generalized to other Riemannian manifolds or to non-Euclidean spaces, such as Lie groups (e.g., SE(3) special Euclidean group). Additionally, control derivations may be generalized to the Lie Groups.

### Lie Groups—Preliminaries

A Lie group [symbol] is a smooth manifold. Thus, any element on the Lie group [symbol] locally resembles a linear space. But unlike other manifolds, elements in a Lie group [symbol] also satisfy the four group axioms equipped with a composition operation: closure, identity, inverse, and associativity. Therefore, the Lie group [symbol] may model non-Euclidean entities, such as rotation or rigid body transformation, while allowing analytical and numerical techniques in the Euclidean space to be applied. In particular, the special orthogonal group SO(3) and the special Euclidean group SE(3) may be used to model 3D rotation and 3D rigid body transformation (e.g., simultaneous rotation and translation), respectively.

As used herein, “SO(3) group” may be defined as follows: the special orthogonal group SO(3) is a matrix manifold, in which each element is a 3-by-3 matrix satisfying the following property:

$${g}^{τ} g = {gg}^{τ} = I and det ( g ) = 1 , {∀}_{g} ∈ SO ( 3 ) ⊂ {ℝ}^{3 \times 3}$$

where I is a 3-by-3 identity matrix. The composition operator for SO(3) is the standard matrix multiplication.

As used herein, “SE(3) group” may be defined as follows: the Special Euclidean group SE(3) is a matrix manifold. Each element of SE(3) is a 4-by-4 matrix that, when used as a transformation between two Euclidean space points, preserves the Euclidean distance between and the handedness of the points. Each element has the following structure:

$$g = [ \begin{matrix}R & t \\ 0 & 1\end{matrix} ] , R ∈ SO ( 3 ) , t , 0 ∈ {ℝ}^{3}$$

The composition operation in SE(3) is the standard matrix multiplication and has the following structure:

$${g}_{1} \cdot {g}_{2} = [ \begin{matrix}{R}_{1} {R}_{2} & {R}_{1} {t}_{2} + {t}_{1} \\ 0 & 1\end{matrix} ] \qquad ( 47 )$$

$${g}_{1} = [ \begin{matrix}{R}_{1} & {t}_{1} \\ 0 & 1\end{matrix} ] , {g}_{2} = [ \begin{matrix}{R}_{2} & {t}_{2} \\ 0 & 1\end{matrix} ] \qquad ( 48 )$$

The smooth manifold property of the Lie group [symbol] means at every element in SO(3) and SE(3), a linear matrix space may be locally defined. This locally defined linear matrix space may be the tangent space of the Lie group [symbol] .

As used herein, “tangent space” may be defined as follows: for an element g on a manifold [symbol] , its tangent space [symbol] is a linear space consisting of all possible tangent vectors that pass through g.

Each element in the tangent space [symbol] may be considered as the time derivative of a temporal trajectory on the manifold g(t) that passes through the g at time t. Given the definition of a Lie group [symbol] , the time derivative of such a trajectory is a vector.

As used herein, “Lie algebra” may be defined as follows: for a Lie group [symbol] , the tangent space [symbol] at its identity element [symbol] is the Lie algebra of this group, denoted as [symbol] .

Despite being a linear space, the tangent space [symbol] on the Lie group [symbol] and Lie algebra may still have non-trivial structures. For example, the Lie algebra of the SO(3) group is the linear space of skew-symmetric matrices. However, elements in Lie algebra may be expressed as a vector on top of a set of generators, which are the derivatives of the tangent element in each direction. Thus, Lie algebra elements may be represented in the standard Euclidean vector space. Elements between the Lie algebra and the standard Euclidean space may be transformed through isomorphisms, such as the hat operator and vee operator, discussed in greater detail herein.

As used herein, the “hat operator” may be defined as follows: the hat operator (\hat{⋅}) is an isomorphism from a n-dimensional Euclidean vector space to the Lie algebra with n-degrees of freedom:

$$( \hat{\cdot } ) : {ℝ}^{n} ↦ ; \hat{v} = {\sum }_{i = 1}^{n} {v}_{i} {E}_{i} ∈ , v ∈ {ℝ}^{n} \qquad ( 49 )$$

where Eᵢ is the i-th generator of the Lie algebra.

As used herein, the “vee operator” may be defined as follows: vee operator ^{v}(⋅): [symbol] is the inverse mapping of the hat operator.

For the SO(3) group, the hat operator is defined as:

$$\hat{ω} = [ \begin{matrix}0 & - {ω}_{e} & {ω}_{2} \\ {ω}_{3} & 0 & - {ω}_{1} \\ - {ω}_{2} & {ω}_{1} & 0\end{matrix} ] , ω ∈ {ℝ}^{3} \qquad ( 50 )$$

For the SE(3) group, the hat operator is defined as:

$$\hat{τ} = [ \begin{matrix}\hat{ω} & v \\ 0 & 0\end{matrix} ] ∈ {ℝ}^{4 \times 4} , τ = [ \begin{matrix}ω \\ v\end{matrix} ] ∈ {ℝ}^{6} , ω , v ∈ {ℝ}^{3} \qquad ( 51 )$$

As used herein, “exponential map” may be defined as follows: an exponential map, denoted as exp: [symbol] , maps an element from the Lie algebra to the Lie group [symbol] .

As used herein, “logarithm map” may be defined as follows: a logarithm map, denoted as log: [symbol] , maps an element from the Lie algebra to the Lie group [symbol] .

The exponential and logarithm map for the SO(3) and SE(3) groups may be computed as desired. For example, the exponential map for the SO(3) group may be computed using Rodrigues' rotation formula.

As used herein, “adjoint” may be defined as follows: an adjoint of a Lie group element g, denoted as Ad_{g}: [symbol] , transforms the vector in one tangent space to another tangent space. Given two tangent spaces, [symbol] and [symbol] , from two elements of the Lie group [symbol] , the adjoint enables the following transformation:

$${v}_{1} = {Ad}_{{g}_{1}^{- 1} {g}_{2}} ( {v}_{2} ) \qquad ( 52 )$$

Since the adjoint is a linear transformation, the adjoint may be represented as a matrix denoted as [Ad_{g}]. The adjoint matrix for a SO(3) matrix is itself. The adjoint matrix for a SE(3) matrix is:

$$[ {Ad}_{g} ] = [ \begin{matrix}R & \hat{t} R \\ 0 & R\end{matrix} ] ∈ {ℝ}^{6 \times 6} , g = [ \begin{matrix}R & t \\ 0 & 1\end{matrix} ] \qquad ( 53 )$$

### Lie Groups—Kernels

The definition of a Gaussian kernel is built on top of a notion of a “distance” or a quadratic function of the “difference” between the two inputs. In this regard, to define a kernel in a Lie group, quadratic functions in Lie groups may be defined.

As used herein, “quadratic function” with reference to Lie groups may be defined as follows: given two elements g₁, g₂ on the Lie group [symbol] , define the quadratic function as:

$$C ( {g}_{1} , {g}_{2} ) = \frac{1}{2} {‖ log ( {g}_{2}^{- 1} {g}_{1} ) ‖}_{M}^{2} \qquad ( 54 )$$

where M is the weight matrix and log denotes the Lie group logarithm.

The derivatives of the quadratic function, are as follows:

$${D}_{1} C ( {g}_{1} , {g}_{2} ) = d {{exp}^{- 1} ( - log ( {g}_{2}^{- 1} {g}_{1} ) )}^{⊤} M log ( {g}_{2}^{- 1} {g}_{1} ) \qquad ( 55 )$$

$${D}_{2} C ( {g}_{1} , {g}_{2} ) = - {[ {Ad}_{{g}_{1}^{- 1} {g}_{2}} ]}^{T} {D}_{1} C ( {g}_{1} , {g}_{2} ) \qquad ( 56 )$$

where d exp⁻¹ denotes the trivialized tangent inverse of the exponential map.

Based on Equation (54) squared exponential kernel on Lie groups may be defined.

As used herein, “squared exponential kernel” with reference to Lie groups may be defined as follows:

$$Φ ( {g}_{1} , {g}_{2} ; α , M ) = α \cdot exp ( \frac{1}{2} {‖ log ( {g}_{2}^{- 1} {g}_{1} ) ‖}_{M}^{2} ) \qquad ( 57 )$$

### Lie Groups—Probability Distributions

Generalizing Gaussian and Gaussian-mixture distributions to the Lie group as the target distribution are discussed herein. Although the following discussion relates to generalizing Gaussian and Gaussian-mixture distributions to the Lie group, other generalizations, such as the Cauchy distribution and Laplace distribution are contemplated. In any event, the discussion below follows a concentrated Gaussian formula, used for probabilistic state estimation on Lie groups.

As used herein, “Gaussian distribution” may be defined as follows: given a Lie group mean g∈ [symbol] and a covariance matrix Σ whose dimension matches the degrees of freedom of the Lie group [symbol] (e.g., and thus, the dimension of a tangent space [symbol] on the group), a Gaussian distribution may be defined, denoted as [symbol] (g̅, Σ), with the following probability density function:

$${𝒩}_{𝒢} ( g \vert \overline{g} , Σ ) = 𝒩 ( log ( {\overline{g}}^{- 1} ∘ g ) \vert 0 , Σ ) \qquad ( 58 )$$

where [symbol] (0, Σ) is a zero-mean Euclidean Gaussian distribution in the tangent space [symbol] of the mean [symbol] .

Given the above definition, in order to generate a sample g˜ [symbol] (g̅, Σ) from the distribution, the processor 210 may generate a perturbation from the distribution of the tangent space ϵ˜ [symbol] (0, Σ), which will perturb the Lie group mean to generate the sample:

$$g = \overline{g} ∘ exp ( ϵ ) ∼ {𝒩}_{g} ( \overline{g} , Σ ) \qquad ( 59 )$$

$$ϵ ∼ 𝒩 ( 0 , Σ ) \qquad ( 60 )$$

Following this relation, the Lie group Gaussian distribution and the tangent space Gaussian distribution share the same covariance matrix through the following equation:

$$Σ = 𝔼 [ {ϵϵ}^{T} ] = \qquad ( 61 )$$

$$𝔼 [ log ( {\overline{g}}^{- 1} ∘ g ) {log ( {\overline{g}}^{- 1} ∘ g )}^{T} ] \qquad ( 62 )$$

Since the optimal control formula requires the derivative of the target probability density function with respect to the state, the full expression of the probability density function and derive its derivative as follows:

$$P ( g ) = {𝒩}_{𝒢} ( g \vert \overline{g} , Σ ) \qquad ( 63 )$$

$$P ( g ) = {𝒩}_{𝒢} ( log ( {\overline{g}}^{- 1} ∘ g ) \vert 0 , Σ )$$

$$P ( g ) = η \cdot exp ( - \frac{1}{2} {log ( {\overline{g}}^{- 1} g )}^{⊤} {\sum }^{- 1} log ( {\overline{g}}^{- 1} g ) )$$

where η is the normalization term defined as:

$$η = \frac{1}{\sqrt{{( 2 π )}^{n} det ( Σ )}} \qquad ( 64 )$$

The derivative of P(g) is:

$$D P ( g ) = P ( g ) \cdot - {( \frac{d}{d g} log ( {\overline{g}}^{- 1} g ) )}^{⊤} {\sum }^{- 1} log ( {\overline{g}}^{- 1} g ) \qquad ( 65 )$$

where the derivative

$$\frac{d}{d g} log ( {\overline{g}}^{- 1} g )$$

may be further expanded as:

$$\frac{d}{d g} log ( {\overline{g}}^{- 1} g ) = d exp ( - log ( {\overline{g}}^{- 1} g ) \cdot \frac{d}{d g} ( {\overline{g}}^{- 1} g ) ) \qquad ( 66 )$$

$$\frac{d}{d g} log ( {\overline{g}}^{- 1} g ) = d exp ( - log ( {\overline{g}}^{- 1} g ) \qquad ( 67 )$$

where d exp denotes the trivialized tangent of the exponential map.

The formula of concentrated Gaussian distribution on Lie groups perturbs the Lie group mean on the right side of Equation (59). Another formula is to perturb the mean on the left side. The Lie group derivation of the kernel-based ergodic metric ε_{ϕ}(s(t)) holds for both formulas. One difference between the two formulas is the frame in which the perturbation is applied.

### Lie Groups—Dynamics

The trajectory controller 272 may control the system 200 or robot for kernel-based ergodic search to move or travel along the determined trajectory using the one or more actuators 274 and based on the control signal of the trajectory generated by the controller 216, thereby implementing the trajectory for the robot, for example.

For example, given a trajectory evolving on the Lie group g(t): [0, T] [symbol] , define trajectory dynamics in terms of a control vector field:

$$\dot{g} ( t ) = f ( g ( t ) , u ( t ) , t ) ∈ 𝔤 \qquad ( 68 )$$

In order to linearize the dynamics based on the trajectory optimization algorithm from Equation (41), model the dynamics through the left trivialization of the control vector field:

$$λ ( g ( t ) , u ( t ) , t ) = {g ( t )}^{- 1} f ( g ( t ) , u ( t ) , t ) ∈ 𝔤 \qquad ( 69 )$$

which enables the dynamics to be represented as:

$$\dot{g} ( t ) = g ( t ) λ ( g ( t ) , u ( t ) , t ) \qquad ( 70 )$$

Denote a perturbation on the control u(t) as v(t) and the resulting tangent space perturbation on the Lie group state as z(t)∈ [symbol] . In this regard, z(t) exhibits a similar linear dynamics as its Euclidean space counterpart:

$$\dot{z} ( t ) = A ( t ) z ( t ) + B ( t ) v ( t ) \qquad ( 71 )$$

$$A ( t ) = {D}_{1} λ ( g ( t ) , u ( t ) , t ) - [ {Ad}_{{λ}_{( g ( t ) , u ( t ) , t )}} ] \qquad ( 72 )$$

$$B ( t ) = {D}_{2} λ ( g ( t ) , u ( t ) , t ) \qquad ( 73 )$$

Since the linearization of the dynamics is in the tangent space [symbol] , this enables the processor 210 to perform Algorithm 1, and thus, optimize the control for kernel ergodic control on Lie groups.

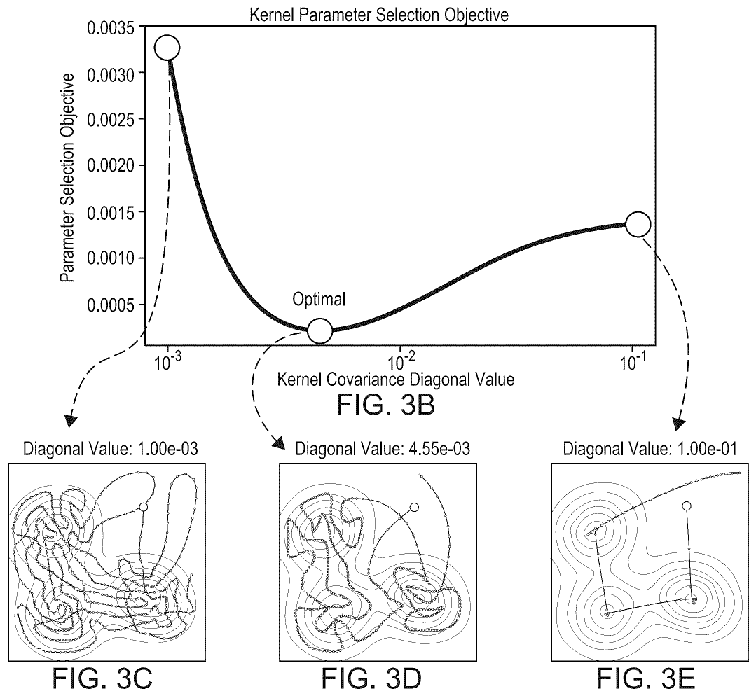

FIGS. 3A-3E are graphs related to kernel-based ergodic search using a robot, according to one aspect. In FIGS. 3A-3E, an example objective function for kernel parameter selection is shown, as well as how different kernel parameters may influence a resulting ergodic trajectory. From FIGS. 3A-3E, it may be seen that the kernel parameter is an adjustable parameter to generate coverage trajectories that balance behaviors between uniform coverage and seeking maximum likelihood estimation. Thus, a kernel parameter could be sub-optimal under the parameter selection objective, yet still generate viable trajectories for practitioners depending on the specific requirements of a task.

FIG. 3A is a graph illustrating samples associated with a target or desired distribution associated with kernel-based ergodic search using a robot, according to one aspect.

FIG. 3B is a graph illustrating a kernel parameter selection objective associated with kernel-based ergodic search using a robot, according to one aspect. For example, the kernel parameter selection objective function from Equation (29) is shown with the given samples from FIG. 3A. In this example, the kernel parameter is the value of the diagonal entry in the covariance.

FIG. 3C is a graph illustrating an “over-uniform” coverage behavior associated with kernel-based ergodic search using a robot, according to one aspect. For example, a sub-optimal kernel parameter may lead to such “over-uniform” coverage behavior.

FIG. 3D is a graph illustrating an exemplary optimal coverage behavior associated with kernel-based ergodic search using a robot, according to one aspect. When the kernel parameter is optimized, the kernel parameter may generate an ergodic trajectory that allocates the time spent in each region to be proportional to the integrated probability density of the region, in accordance with Equation (29).

FIG. 3E is a graph illustrating an “over-concentrated” coverage behavior associated with kernel-based ergodic search using a robot, according to one aspect. For example, another sub-optimal kernel parameter may lead to such “over-concentrated” coverage behavior.

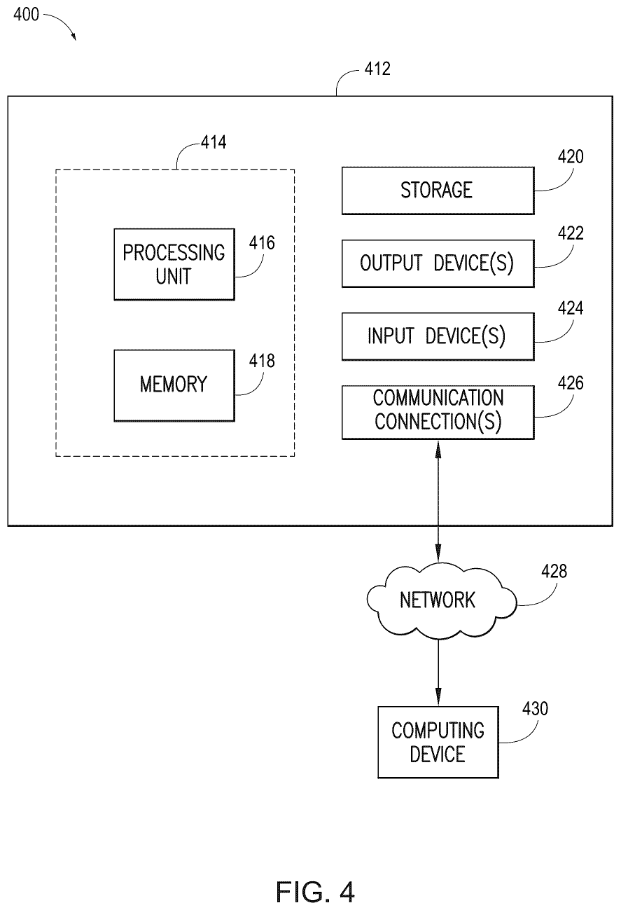

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

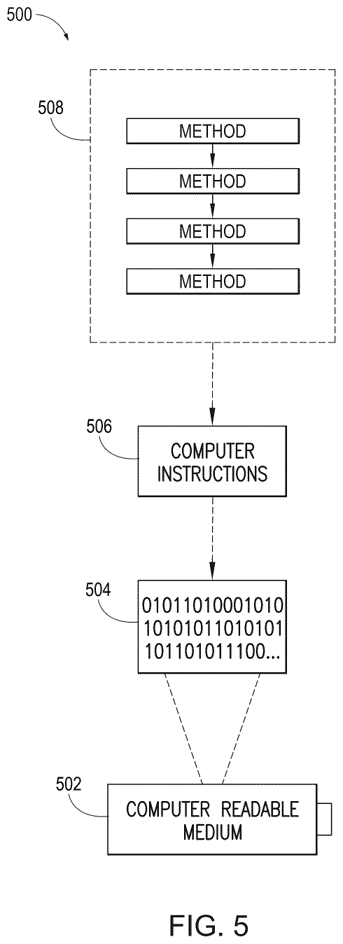

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 100 of FIG. 1. In another aspect, the processor-executable computer instructions 506 may be configured to implement a system, such as the system 200 of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described herein. Rather, the specific features and acts described herein are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, various presently unforeseen or unanticipated alternatives, modifications, variations, or improvements therein may be subsequently made by those skilled in the art which are also intended to be encompassed by the following claims.

1. A computer-implemented method for kernel-based ergodic search using a robot, comprising:
receiving, via a processor, a target distribution indicative of a desired ergodic search coverage;
generating, via a metric generator, a kernel-based ergodic metric based on the target distribution and a candidate trajectory;
generating, via a gradient generator, a kernel-based ergodic gradient based on the kernel-based ergodic metric;
generating, via a controller, a trajectory based on the kernel-based ergodic gradient; and
implementing, via a trajectory controller, the trajectory for the robot.

2. The computer-implemented method for kernel-based ergodic search using the robot of claim 1, wherein the kernel-based ergodic metric is based on a delta kernel.

3. The computer-implemented method for kernel-based ergodic search using the robot of claim 1, wherein the kernel-based ergodic metric is based on an L2 distance between the target distribution and a spatial empirical distribution of the candidate trajectory.

4. The computer-implemented method for kernel-based ergodic search using the robot of claim 1, wherein the kernel-based ergodic metric includes an information maximization element and a uniform coverage element.

5. The computer-implemented method for kernel-based ergodic search using the robot of claim 1, wherein the kernel-based ergodic metric is formulated as a Gaussian kernel.

6. The computer-implemented method for kernel-based ergodic search using the robot of claim 1, comprising performing kernel parameter selection for the kernel-based ergodic metric based on a kernel parameter selection objective function by minimizing a derivative of one or more independent and identically distributed (IID) samples from the target distribution with respect to the kernel-based ergodic metric.

7. The computer-implemented method for kernel-based ergodic search using the robot of claim 1, comprising generating the trajectory based on iteratively optimizing a descent direction of a kernel ergodic control objective associated with the kernel-based ergodic metric with a quadratic cost.

8. The computer-implemented method for kernel-based ergodic search using the robot of claim 7, wherein the iteratively optimizing the descent direction is based on a linear-quadratic regulator (LQR).

9. The computer-implemented method for kernel-based ergodic search using the robot of claim 1, wherein the kernel-based ergodic metric is generalized to a Lie group.

10. The computer-implemented method for kernel-based ergodic search using the robot of claim 9, wherein the Lie group is a special orthogonal group SO(3) or a special Euclidean group SE(3).

11. A system for kernel-based ergodic search using a robot, comprising:
a memory storing one or more instructions;
a processor executing one or more of the instructions stored on the memory to perform:
receiving a target distribution indicative of a desired ergodic search coverage;
generating a kernel-based ergodic metric based on the target distribution and a candidate trajectory;
generating a kernel-based ergodic gradient based on the kernel-based ergodic metric; and
generating a trajectory based on the kernel-based ergodic gradient; and
a trajectory controller implementing the trajectory for the robot.

12. The system for kernel-based ergodic search using a robot of claim 11, wherein the kernel-based ergodic metric is based on a delta kernel.

13. The system for kernel-based ergodic search using a robot of claim 11, wherein the kernel-based ergodic metric is based on an L2 distance between the target distribution and a spatial empirical distribution of the candidate trajectory.

14. The system for kernel-based ergodic search using a robot of claim 11, wherein the kernel-based ergodic metric includes an information maximization element and a uniform coverage element.

15. The system for kernel-based ergodic search using a robot of claim 11, wherein the kernel-based ergodic metric is formulated as a Gaussian kernel.

16. A robot for kernel-based ergodic search, comprising:
a memory storing one or more instructions;
a processor executing one or more of the instructions stored on the memory to perform:
receiving a target distribution indicative of a desired ergodic search coverage;
generating a kernel-based ergodic metric based on the target distribution and a candidate trajectory;
generating a kernel-based ergodic gradient based on the kernel-based ergodic metric; and
generating a trajectory based on the kernel-based ergodic gradient; and
a trajectory controller and one or more actuators implementing the trajectory for the robot.

17. The robot for kernel-based ergodic search of claim 16, wherein the processor performs kernel parameter selection for the kernel-based ergodic metric based on a kernel parameter selection objective function by minimizing a derivative of one or more independent and identically distributed (IID) samples from the target distribution with respect to the kernel-based ergodic metric.

18. The robot for kernel-based ergodic search of claim 16, wherein the processor generates the trajectory based on iteratively optimizing a descent direction of a kernel ergodic control objective associated with the kernel-based ergodic metric with a quadratic cost.

19. The robot for kernel-based ergodic search of claim 18, wherein the iteratively optimizing the descent direction is based on a linear-quadratic regulator (LQR).

20. The robot for kernel-based ergodic search of claim 16, wherein the kernel-based ergodic metric is generalized to a Lie group.
